(19) United States
(12) Patent Application Publication
(10) Pub. No.: US 2025/0239809 A1
(43) Pub. Date: Jul. 24, 2025

(54) ELECTRICAL CONNECTOR AND CONNECTOR DEVICE

(71) Applicant: I-PEX Inc., Kyoto-shi (JP)

(72) Inventor: Takashi MASUNAGA, Ogori-city (JP)

(21) Appl. No.: 19/023,307

(22) Filed: Jan. 16, 2025

(30) Foreign Application Priority Data
Jan. 19, 2024 (JP) 2024-006934

(51) Int. Cl. H01R 13/629; H01R 12/75

(52) U.S. Cl. CPC H01R 13/629; H01R 12/75

(57) ABSTRACT

A connector device includes a plug connector and a lock member. The lock member includes a lock engagement portion configured to be engageable with a connector engagement portion provided for a receptacle connector, and a release operation portion configured to enable an operation for releasing the engagement between the connector engagement portion and the lock engagement portion. The plug connector includes the guide portions that abut on part of the lock engagement portions when the above-described operation for releasing the engagement is performed. When the operation for releasing the engagement is performed, the guide portions (specifically, the inclined portions) abut on the release guide portions of the lock engagement portions, thereby restricting a direction of the operation to a direction of releasing the engagement between the connector engagement portions and the lock engagement portions.

### CROSS-REFERENCE TO RELATED APPLICATIONS

This application claims the benefit of priority from Japanese Patent Application No. 2024-006934, filed on Jan. 19, 2024, the entire contents of which are incorporated herein by reference.

### BACKGROUND

### Field

The present disclosure relates to an electrical connector and a connector device.

### Description of the Related Art

Japanese Unexamined Patent Publication No. 2014-35851 discloses a connector device in which a cable-side connector and a board-side connector are fitted in a vertical direction. A lock hole is formed in a first lock portion of the cable-side connector, and a lock protrusion is formed in a second lock portion of the board-side connector, and the lock protrusion is fitted into the lock hole at a time of fitting.

### SUMMARY

An electrical connector according to an aspect of the present disclosure includes a connector portion configured to be fitted to a mating connector along a first direction and to which a connection member extending in a second direction intersecting the first direction is connected, and a lock member attached to the connector portion and configured to maintain a fitted state where the connector portion and the mating connector are fitted to each other, in which the lock member includes at least one lock engagement portion configured to be engageable with at least one connector engagement portion provided for the mating connector and at least one release operation portion coupled to the lock engagement portion and configured to enable an operation for releasing the engagement between the connector engagement portion and the lock engagement portion, the connector portion includes a guide portion that abuts on part of the lock engagement portion when the operation for releasing the engagement is performed, and the guide portion abuts, when the operation for releasing the engagement is performed, on the part of the lock engagement portion to restrict a direction of the operation to a direction of releasing the engagement between the connector engagement portion and the lock engagement portion.

The connector portion may include a plurality of conductive terminals, a housing that holds the plurality of conductive terminals, and a shell that covers the housing, and the guide portion may be formed on the shell.

The lock member may further include a main body portion configured to sandwich the connector portion in the fitted state between the lock member and the mating connector and connected to the lock engagement portion, and a direction in which the lock engagement portion extends and a direction in which the main body portion extends may be orthogonal to each other.

A notch may be formed in part of the lock engagement portion.

The lock member may further include a main body portion configured to sandwich the connector portion in the fitted state between the lock member and the mating connector, and a coupling portion that couples the lock engagement portion and the main body portion to each other, a direction in which the lock engagement portion extends and a direction in which the main body portion extends may be orthogonal to each other, and the coupling portion may extend in a U-shape and be coupled to the lock engagement portion and the main body portion.

A notch may be formed in part of at least one of the lock engagement portion and the coupling portion.

The lock engagement portion may swing about a center of a U-shaped shaft of the coupling portion as an axis of rotation when the operation for releasing the engagement is performed.

A connector device according to another aspect of the present disclosure includes a first connector to which a connection member extending in a second direction intersecting a first direction is connected, a second connector connected to a board and fitted to the first connector along the first direction, and a lock member attached to the first connector and configured to maintain a fitted state where the first connector and the second connector are fitted to each other, in which the lock member includes at least one lock engagement portion configured to be engageable with at least one connector engagement portion provided for the second connector and at least one release operation portion coupled to the lock engagement portion and configured to enable an operation for releasing the engagement between the connector engagement portion and the lock engagement portion, the first connector includes a guide portion that abuts on part of the lock engagement portion when the operation for releasing the engagement is performed, and the guide portion abuts, when the operation for releasing the engagement is performed, on part of the lock engagement portion to restrict a direction of the operation to a direction of releasing the engagement between the connector engagement portion and the lock engagement portion.

### Effect of the Invention

According to the present disclosure, an electrical connector and a connector device capable of smoothly releasing a lock may be provided.

### BRIEF DESCRIPTION OF THE DRAWINGS

FIG. 1 is a perspective view illustrating a connector device according to a first embodiment;

FIG. 2 is a plan view illustrating the connector device of FIG. 1;

FIG. 3 is a side view illustrating the connector device of FIG. 1;

FIG. 4 is an enlarged view of a part of a rear view illustrating the connector device of FIG. 1;

FIG. 5 is an enlarged view of a part of a cross-sectional view taken along line V-V in FIG. 2;

FIG. 6 is a cross-sectional view taken along line VI-VI of FIG. 2;

FIGS. 7A and 7B are perspective views illustrating a receptacle connector included in the connector device of FIG. 1;

FIGS. 8A and 8B are perspective views illustrating a plug connector and a lock member included in the connector device of FIG. 1;

FIG. 9 is a perspective view of the plug connector, excluding the lock member, included in the connector device of FIG. 1;

FIGS. 10A and 10B are perspective views illustrating the lock member included in the connector device of FIG. 1;

FIGS. 11A to 11D are diagrams schematically illustrating a procedure for unlocking the connector device;

FIG. 12 is a perspective view illustrating a part of a connector device according to a second embodiment;

FIG. 13 is an enlarged view of a part of a rear view illustrating the connector device of FIG. 12;

FIG. 14 is a side view illustrating the connector device of FIG. 12; and

FIGS. 15A and 15B are perspective views illustrating a lock member included in the connector device of FIG. 12.

### DETAILED DESCRIPTION

In the following description, with reference to the drawings, the same reference numbers are assigned to the same components or to similar components having the same function, and overlapping description is omitted.

Embodiments according to the present disclosure will be described in detail hereinafter with reference to the drawings. In the drawings, the same elements or elements having the same functions are given the same reference numerals, and redundant description thereof might be omitted. In each drawing, directions indicated by arrows might be referred to as an X-axis direction, a Y-axis direction, and a Z-axis direction. In the drawings, a positive Z-axis direction might be referred to as “upward”, and a negative Z-axis direction might be referred to as “downward”. In each drawing, a positive X-axis direction might be referred to as “back”, and a negative X-axis direction might be referred to as “front”. It is assumed in the following description that a first direction is along the Z-axis direction, a second direction is along the X-axis direction, and a third direction is along the Y-axis direction. Since the embodiments according to the present disclosure described below are examples for describing the present invention, the present invention should not be limited to the following content.

### First Embodiment

### [Connector Device]

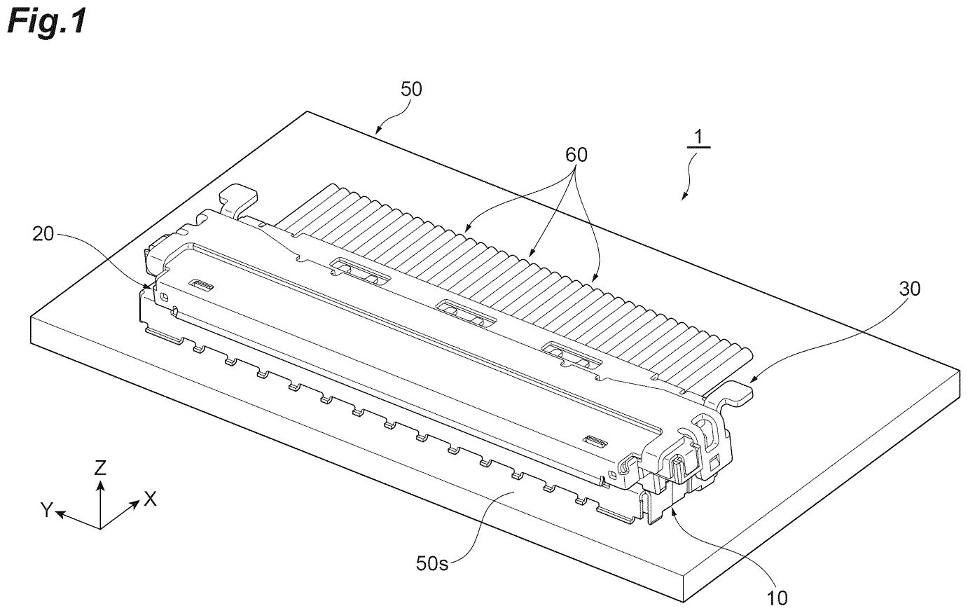

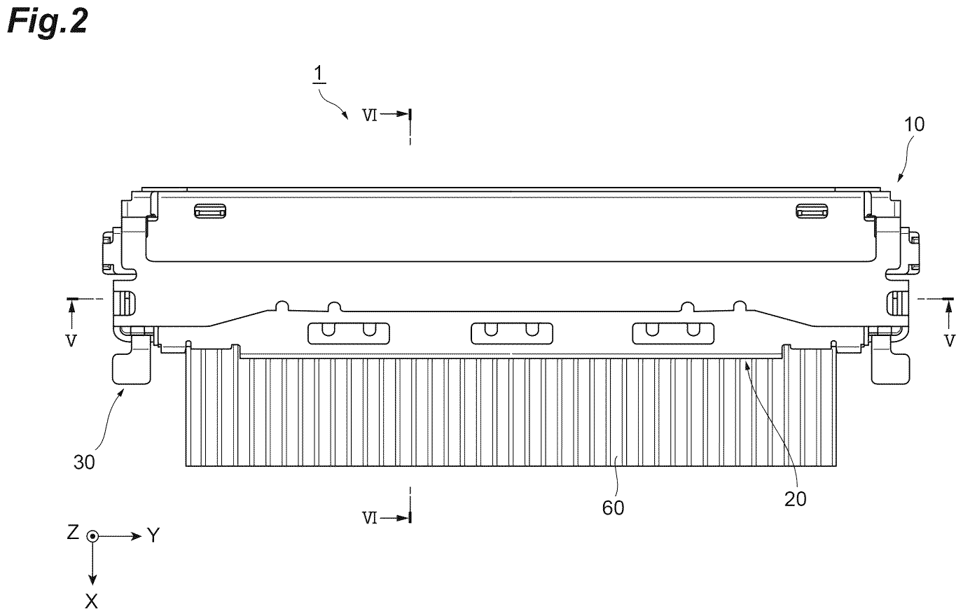

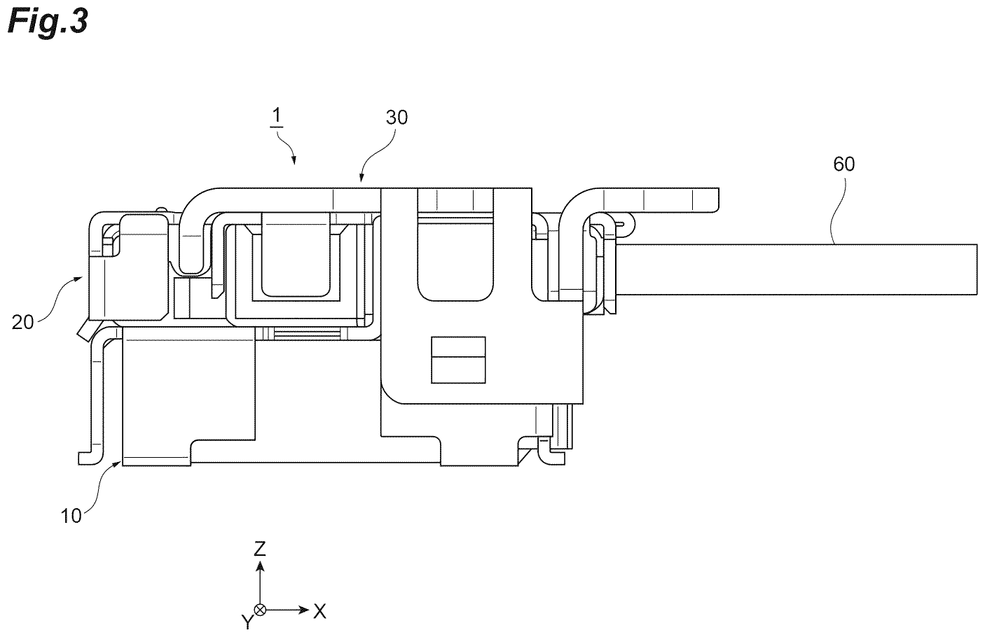

An outline of a connector device 1 will be described with reference to FIGS. 1 to 3. As illustrated in FIGS. 1 to 3, the connector device 1 includes a receptacle connector 10 (a mating connector or a second connector) and an electrical connector including a plug connector 20 (a connector portion or a first connector) and a lock member 30. The receptacle connector 10 is attached to a circuit board 50 and electrically connected to the circuit board 50. The plug connector 20 is attached to electric cables 60 (connection members) and electrically connected to the electric cables 60.

The receptacle connector 10 and the plug connector 20 are configured to be able to be fitted to and removed from each other along the first direction (for example, the Z-axis direction) intersecting a main surface 50s (for example, an XY plane) of the circuit board 50. The lock member 30 is configured to keep a fitted state, in which the receptacle connector 10 and the plug connector 20 are fitted to each other. In the fitted state of the receptacle connector 10 and the plug connector 20, conductive paths (wires, for example, which are not illustrated) formed on the main surface 50s of the circuit board 50 are electrically connected to the electric cables 60. As described above, the connector device 1 is a device for electrically and physically connecting the conductive paths and the electric cables to each other.

The circuit board 50 is one of various boards on which electronic circuits and electronic components are mounted, and is, for example, a printed wiring board or a flexible printed board. In the circuit board 50, the receptacle connector 10 is mounted on the main surface 50s through solder connection or the like.

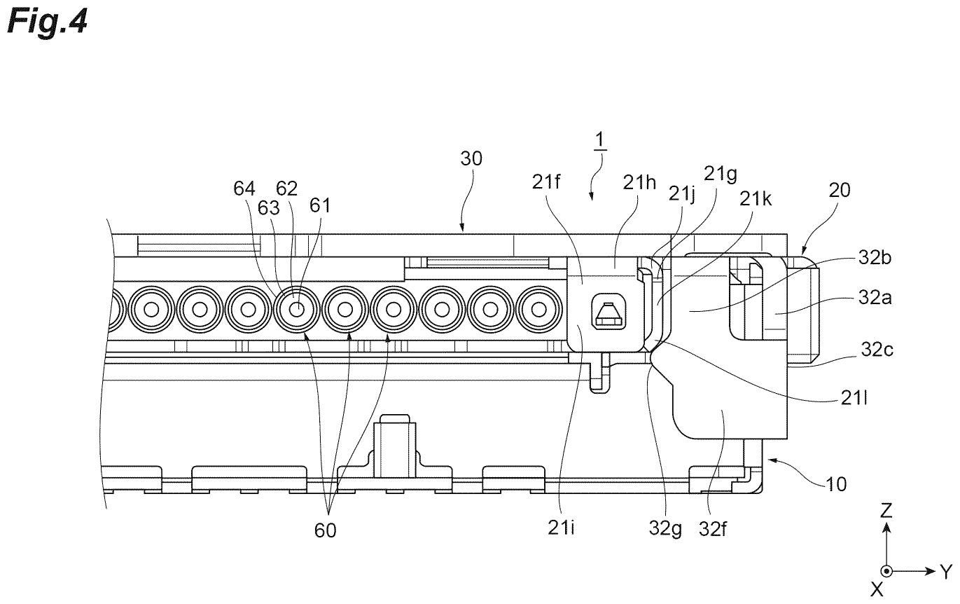

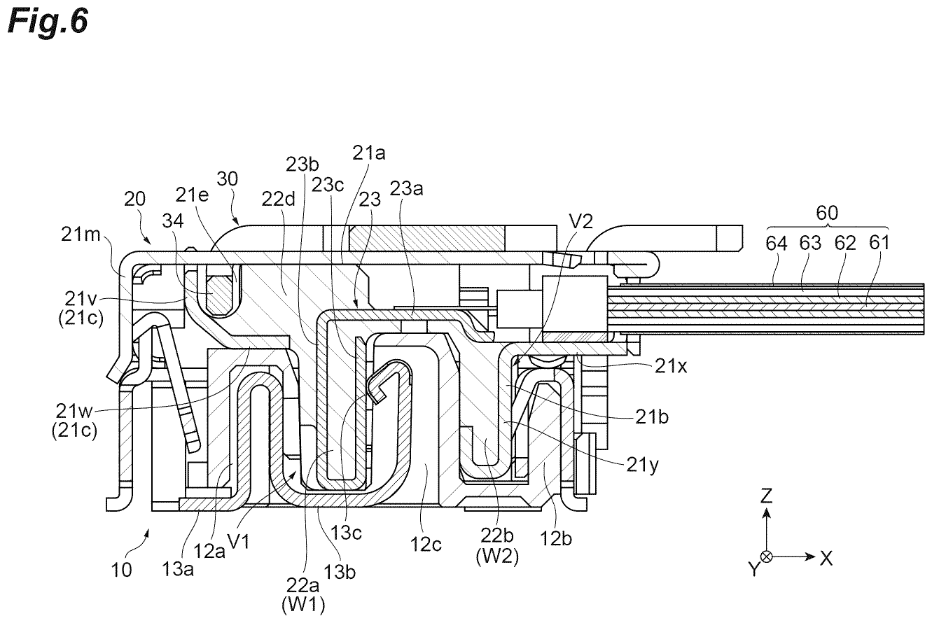

The electric cables 60 are wiring used to transmit signals and the like between various circuit boards built in a small electronic device such as a mobile phone. The electric cable 60 extends along the second direction (for example, the X-axis direction) intersecting the first direction in the fitted state of the receptacle connector 10 and the plug connector 20. The electric cables 60 each include an inner conductor 61 made of a linearly extending metal wire (for example, a copper wire), an insulator 62 covering a peripheral surface of the inner conductor 61, an outer conductor 63 made of a cylindrical braided metal wire and covering a peripheral surface of the insulator 62, and a protective film 64 covering a peripheral surface of the outer conductor 63 (see FIGS. 4 and 6).

In each of the electric cables 60, the inner conductor 61, the insulator 62, the outer conductor 63, and the protective film 64 are exposed stepwise in this order from a distal end portion (terminal portion) to which the plug connector 20 is attached toward a proximal end portion (terminal portion opposite to the distal end portion). For example, the electric cables 60 are coaxial cables or the like. The electric cables 60 may include a plurality of coaxial cables arranged side-by-side in the Y-axis direction. That is, the plug connector 20 may be a connector for coaxial cables extending along the third direction (for example, the Y-axis direction) intersecting both the first direction and the second direction. An electric cable 60 having a structure different from that of a coaxial cable may be provided.

### Receptacle Connector

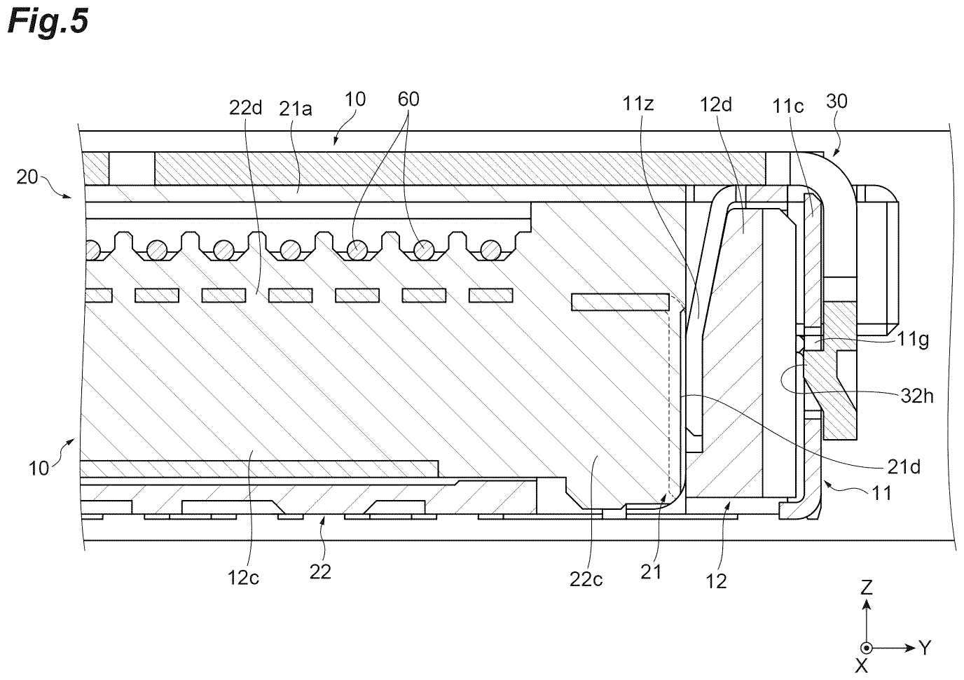

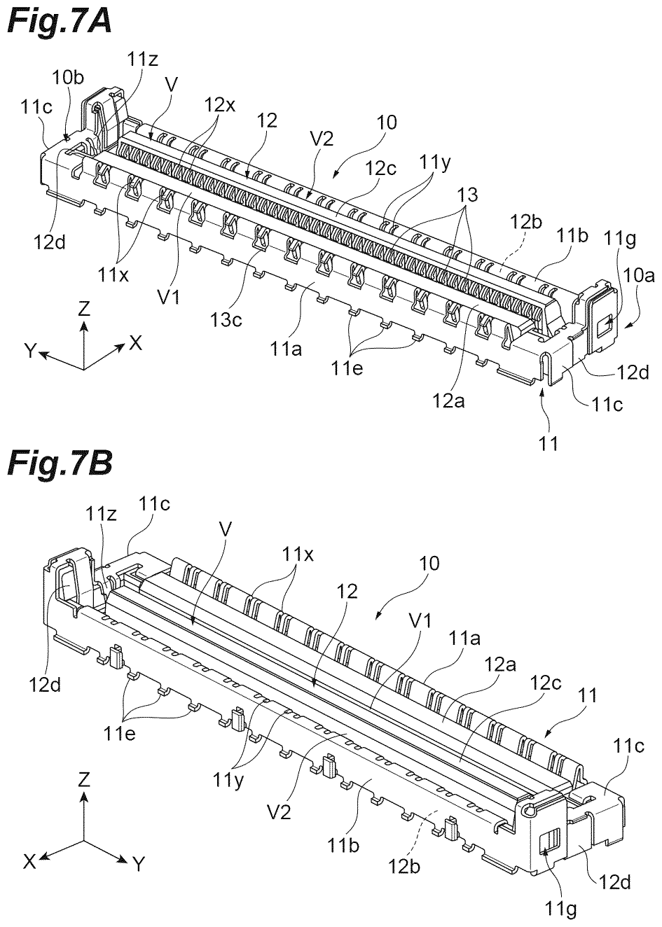

The receptacle connector 10 will be described in detail with reference to FIGS. 5 to 7B. The receptacle connector 10 is an elongated connector extending along the Y-axis direction as a whole, and is attached to the main surface 50s of the circuit board 50 (see FIG. 1). As illustrated in FIG. 7A, therefore, one end 10a and another end 10b of the receptacle connector 10 face each other in the Y-axis direction. As illustrated in FIGS. 7A and 7B, the receptacle connector 10 includes a shell 11, a housing 12, and a plurality of conductive terminals 13.

The housing 12 is made of an insulating material containing resin, holds the plurality of conductive terminals 13, and insulates the shell 11 and the conductive terminals 13 from each other. As illustrated in FIGS. 5 to 7B, for example, the housing 12 includes side walls 12a and 12b, a central wall 12c, side walls 12d and 12d, and a bottom wall 12e. The bottom wall 12e is a plate-like member having a substantially rectangular shape. The side walls 12a and 12b, the central wall 12c, and the side walls 12d and 12d are provided on the bottom wall 12e in such a way as to be erected from the bottom wall 12e.

The side walls 12a and 12b are located near long sides of the bottom wall 12e, and extend in the Y-axis direction along the long sides. The side walls 12a and 12b, therefore, face each other in the X-axis direction. The side wall 12a is provided in such a way as to house part of the conductive terminals 13 therein (surround part of the conductive terminals 13). An outer surface and an inner surface of the side wall 12b in the X-axis direction are covered with a side wall 11b (described later) of the shell 11. The side walls 12d and 12d are located in the vicinity of short sides of the bottom wall 12e and extend in the X-axis direction along the short sides. The side walls 12d and 12d, therefore, face each other in the Y-axis direction. Outer surfaces and inner surfaces of the side walls 12d and 12d in the Y-axis direction are covered with side walls 11c (described later) of the shell 11.

The central wall 12c is located in a space surrounded by the side walls 12a, 12b, 12d, and 12d while being separated from the side walls 12a, 12b, 12d, and 12d. The central wall 12c extends along the side walls 12a and 12b (in the Y-axis direction, in which the side walls 12a and 12b extend) between the side walls 12a and 12b. The central wall 12c, therefore, faces the side walls 12a and 12b in the X-axis direction. A plurality of notches 12x for exposing the conductive terminals 13 is formed in a surface of the central wall 12c facing the side wall 12a.

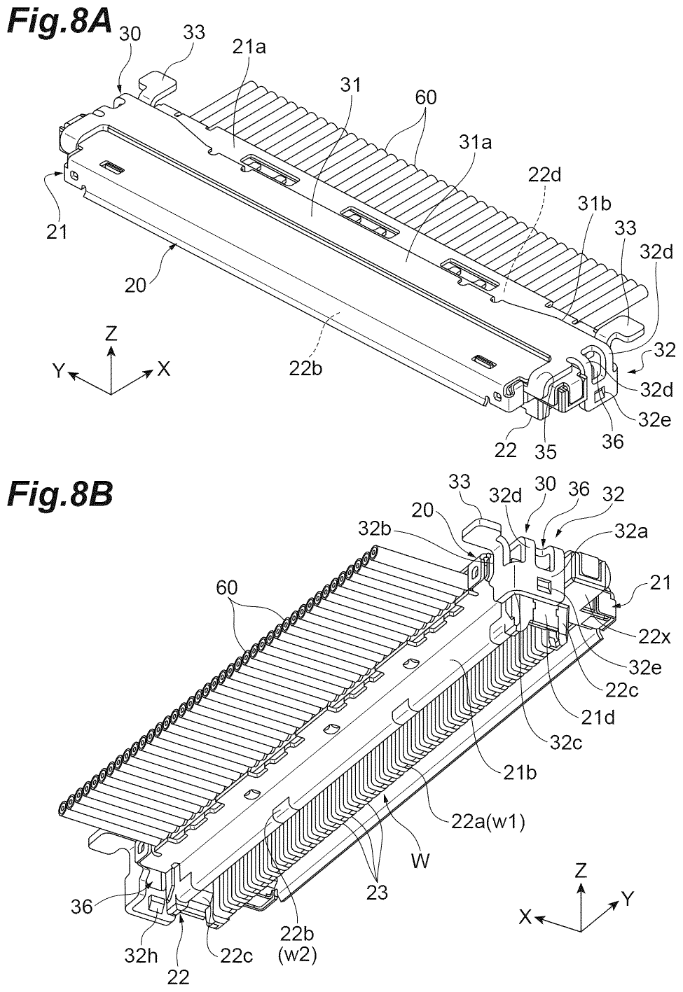

The housing 12 has, by including the side walls 12a and 12b, the central wall 12c, the side walls 12d and 12d, and the bottom wall 12e, a recess V having a quadrangular annular shape. The recess V is a space for accommodating the plug connector 20, and include a pair of recesses V1 and V2. The recess V1 is formed by a space surrounded by the side wall 12a, the central wall 12c, and the bottom wall 12e, and accommodates a protrusion W1 (see FIG. 8B) of the plug connector 20. The recess V2 is formed by a space surrounded by the side wall 12b, the central wall 12c, and the bottom wall 12e, and accommodates a protrusion W2 (see FIG. 8B) of the plug connector 20.

The shell 11 is formed of, for example, a pressed metal plate-like member, and has elasticity and conductivity. As illustrated in FIGS. 7A and 7B, for example, the shell 11 includes side walls 11a, 11b, 11c, and 11c, a plurality of protrusions 11e, and connector engagement portions 11g and 11g. The shell 11 is fixed to the housing 12 as a result of engagement between protrusions formed on the side wall 12b of the housing 12 and notches formed in the side wall 11b. Another fixing means may be provided.

As illustrated in FIGS. 6, 7A, and 7B, the side walls 11a and 11b face each other in the X-axis direction and extend along the Y-axis direction. The side wall 11a is located outside the side wall 12a of the housing 12 in the X-axis direction. The side wall 11a extends upward from the main surface 50s of the circuit board 50 and is curved toward the side wall 11b at an upper end thereof (that is, folded back inward in the X-axis direction), and is configured to be elastically deformable in the X-axis direction. A plurality of slits 11x is formed in a folded portion (an inner portion in the X-axis direction) of the side wall 11a. As a result, the side wall 11a is readily bent in the X-axis direction. The side wall 11b is provided in such a way as to cover the outer surface and the inner surface of the side wall 12b of the housing 12 in the X-axis direction. The side wall 11b extends upward from the main surface 50s of the circuit board 50 along the outer surface of the side wall 12b, is curved toward the side wall 11a at an upper end thereof (that is, folded back inward in the X-axis direction and extends downward along the inner surface of the side wall 12b), and is configured to be elastically deformable in the X-axis direction. A plurality of slits 11y is formed in a folded portion (an inner portion in the X-axis direction) of the side wall 11b. As a result, the side wall 11b is readily bent in the X-axis direction. Height (length in the Z-axis direction) of the side wall 11b is about half that of the side wall 11a.

As illustrated in FIGS. 7A and 7B, the side walls 11c and 11c face each other in the Y-axis direction and extend along the X-axis direction. The side walls 11c are provided in such a way as to cover outer surfaces and inner surfaces of the side walls 12d of the housing 12 in the Y-axis direction. The side walls 11c and 11c are connected to the side walls 11a and 11b. The side walls 11c include ground contact portions 11z at a central portion thereof in the X-axis direction. The ground contact portions 11z are portions curved from upper ends of the side walls 11c toward the opposing side walls 11c (toward the recess V), and are configured to be elastically deformable in the Y-axis direction. The ground contact portions 11z may have notches for facilitating bending.

As illustrated in FIGS. 7A and 7B, the plurality of protrusions 11e is provided in such a way as to protrude outward (opposite to the recess V) at lower ends of the side walls 11a and 11b, and are arranged side-by-side along the Y-axis direction. The protrusions 11e may be provided in such a way as to further protrude outward (opposite to the recess V) at lower ends of the side walls 11c and 11c. Surfaces of the protrusions 11e coming into contact with the main surface 50s of the circuit board 50 are electrically connected to the conductive paths of the circuit board 50 via, for example, solder. That is, the protrusions 11e include attachment surfaces configured to be attachable to the main surface 50s of the circuit board 50.

The connector engagement portions 11g and 11g are configured to be engageable with lock engagement portions 32 of the lock member 30 described later. The connector engagement portions 11g and 11g are arranged at the ends 10a and 10b, respectively. As illustrated in FIGS. 5, 7A, and 7B, the connector engagement portions 11g and 11g are recesses formed in the side walls 11c and 11c. The connector engagement portions 11g and 11g are arranged on the side walls 11c and 11c closer to a rear side. Note that shapes of the connector engagement portions 11g and 11g are not limited to recesses, and may be, for example, notches or the like provided in the side walls 11c and 11c, instead.

The plurality of conductive terminals 13 is formed of, for example, a pressed metal plate-like member, and have elasticity and conductivity. As illustrated in FIG. 7A, the plurality of conductive terminals 13 is arranged side-by-side along the Y-axis direction. As illustrated in FIG. 6, the conductive terminals 13 extend along the X-axis direction and each include a base end portion 13a, an intermediate portion 13b, and a contact portion 13c.

The base end portion 13a is disposed on the main surface 50s of the circuit board 50 and connected to one of the conductive paths of the circuit board 50 via, for example, solder. The base end portion 13a is located below the side wall 12a of the housing 12.

The intermediate portion 13b connects the base end portion 13a and the contact portion 13c. The intermediate portion 13b extends along the side wall 12a of the housing 12, is bent in a U-shape inside, and then extends to the vicinity of the central wall 12c along the main surface 50s of the circuit board 50.

As illustrated in FIG. 6, the contact portion 13c comes into contact with one of conductive terminals 23 of the plug connector 20, which will be described later, in the fitted state of the receptacle connector 10 and the plug connector 20. The contact portion 13c extends upward along the central wall 12c, and a tip portion thereof is curved to expose a part thereof in the recess V between the central wall 12c and the side wall 12a (exposed from the corresponding notch 12x in the central wall 12c). The contact portion 13c is thus configured to be elastically deformable in the X-axis direction.

### Plug Connector

Next, the plug connector 20 will be described in detail with reference to FIGS. 5, 6, 8A, 8B, and 9. The plug connector 20 is configured to be fitted to the receptacle connector 10, which is the mating connector, along the Y-axis direction, and is a connector to which the electric cables 60 are connected. As illustrated in FIGS. 8A and 8B, the plug connector 20 includes a shell 21, a housing 22, and a plurality of conductive terminals 23.

The housing 22 is made of an insulating material containing resin, holds the plurality of conductive terminals 23, and insulates the shell 21 and the conductive terminals 23 from each other. As illustrated in FIGS. 6, 8A, and 8B, for example, the housing 22 includes side walls 22a and 22b, side walls 22c and 22c, and an upper wall 22d. The upper wall 22d (see FIG. 6) is a plate-like member having a substantially rectangular shape. An upper surface of the upper wall 22d is covered with an upper wall 21a (described later) of the shell 21. The side walls 22a and 22b and the side walls 22c and 22c are provided in such a way as to descend from the upper wall 22d.

The side walls 22a and 22b are located near long sides of the upper wall 22d, and extend in the Y-axis direction along the long sides. The side walls 22a and 22b, therefore, face each other in the X-axis direction. As illustrated in FIG. 6, the conductive terminals 23 are provided on the side wall 22a. The side wall 22a has an outer surface and an inner surface partially covered with the conductive terminals 23 in the X-axis direction. An inner surface and an outer surface of the side wall 22b are covered with a side wall 21b (described later) of the shell 21 in the X axis direction. The side walls 22c and 22c are located near short sides of the upper wall 22d and extend in the X-axis direction along the short sides. The side walls 22c and 22c, therefore, face each other in the Y-axis direction. On upper end portions of the side walls 22c and 22c, projecting portions 22x projecting further outward from the side walls 22c and 22c in the Y-axis direction are provided (see FIG. 8B). As illustrated in FIG. 8B, the projecting portions 22x function as portions on which the lock member 30 is placed in a state where the lock member 30 is attached to the plug connector 20.

The side walls 22a, 22b, 22c, and 22c are accommodated in the recess V in the receptacle connector 10 when the plug connector 20 is fitted to the receptacle connector 10. The side walls 22a, 22b, 22c, and 22c, therefore, constitute a protrusion W having a protruding shape as a whole. The side walls 22a and 22b constitute a pair of protrusions W1 and W2, which are accommodated in the pair of recesses V1 and V2, respectively. That is, the side wall 22a constituting the protrusion W1 is accommodated in the recess V1, and the side wall 22b constituting the protrusion W2 is accommodated in the recess V2 (see FIG. 6). As illustrated in FIG. 6, in a state where the plug connector 20 is fitted to the receptacle connector 10, the conductive terminals 23 provided on the side wall 22a (protrusion W1) and the conductive terminals 13 exposed from the notches 12x in the central wall 12c constituting the recess V2 come into contact with each other to constitute, for example, part of a signal circuit.

The shell 21 is formed of, for example, a pressed metal plate-like member, and has elasticity and conductivity. As illustrated in FIGS. 5, 6, 8A and 8B, for example, the shell 21 includes the upper wall 21a, the side wall 21b, a front portion 21c (see FIG. 6), a ground contact portion 21d, and a bearing 21e (see FIG. 6).

As illustrated in FIG. 6, the upper wall 21a covers the distal end portions of the electric cables 60 and covers the upper surface of the upper wall 22d of the housing 22. The upper wall 21a extends in the Y-axis direction as illustrated in FIGS. 5 and 8A. The upper wall 21a has portions covering upper surfaces of the projecting portions 22x (see FIG. 8B) and outer surfaces (side surfaces) in the Y-axis direction. The upper wall 21a of the shell 21 is attached to the housing 22 after placement (attachment) of the lock member 30 on the plug connector 20 is completed.

As illustrated in FIG. 6, the side wall 21b is provided in such a way as to cover the side wall 22b of the housing 22. The side wall 21b has a first portion 21x and a second portion 21y. The first portion 21x extends in the Y-axis direction in such a way as to sandwich the distal end portions of the electric cables 60 between the first portion 21x and the upper wall 21a. The second portion 21y is continuous with a front end of the first portion 21x in the X-axis direction, and provided in accordance with a shape of the side wall 22b in such a way as to cover part of the outer surface and the inner surface of the side wall 22b in the X-axis direction. That is, the second portion 21y extends downward from the front end of the first portion 21x along the outer surface of the side wall 22b, is curved toward the inner surface of the side wall 22b at a lower end of the side wall 22b, and extends upward along the inner surface of the side wall 22b.

As illustrated in FIG. 6, the front portion 21c covers the outer surface of the upper wall 22d of the housing 22 in the X-axis direction. The front portion 21c has a first portion 21v and a second portion 21w. The first portion 21v is provided in such a way as to extend downward at a position near the front end of the upper wall 21a. The second portion 21w is continuous with a lower end of the first portion 21v, extends rearward in the X-axis direction, and covers a lower surface of the upper wall 22d. As illustrated in FIG. 6, the second portion 21w is provided along an upper surface of the side wall 12a of the housing 12 of the receptacle connector 10 in the state where the plug connector 20 and the receptacle connector 10 are fitted to each other.

As illustrated in FIGS. 5 and 8B, the ground contact portion 21d is provided in such a way as to cover part of outer surfaces of the side walls 22c of the housing 22 in the Y-axis direction. As illustrated in FIG. 5, the ground contact portion 21d constitutes part of a ground circuit by coming into contact with the ground contact portions 11z of the receptacle connector 10 in the state where the plug connector 20 and the receptacle connector 10 are fitted to each other.

The bearing 21e holds a rotary shaft 34 of the lock member 30, which will be described later. As illustrated in FIG. 6, the bearing 21e is provided at the front end of the upper wall 21a in the X-axis direction, and provided in an entire region in the Y-axis direction or at least at both ends in the Y-axis direction. The bearing 21e is provided near a lower surface of the upper wall 21a and has, for example, a U-shaped cross section hollowed out at the center as illustrated in FIG. 6, and is formed in such a way as to be able to receive (place) the rotary shaft 34 together with the upper wall 21a and the first portion 21v.

The front end of the upper wall 21a is bent in the Z-axis direction to form a flange portion 21m. The flange portion 21m is in contact with the side wall 11a of the receptacle connector 10 to constitute part of the ground circuit.

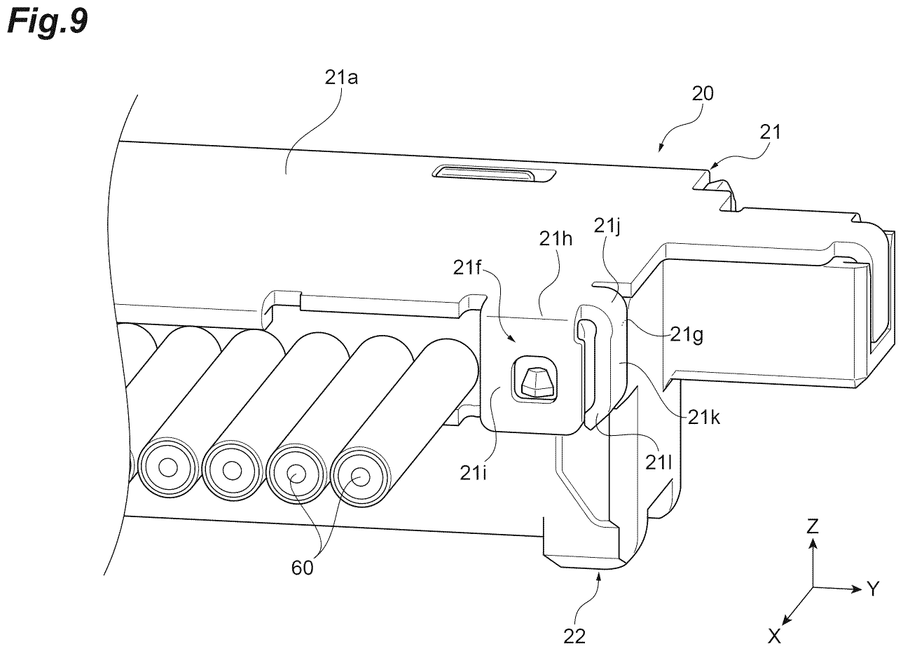

As illustrated in FIG. 9, the shell 21 further includes rear portions 21f and guide portions 21g.

The rear portions 21f are provided in such a way as to be continuous to both ends of the upper wall 21a in the Y-axis direction and a rear end portion of the upper wall 21a in the X axis direction. The rear portions 21f are provided on a surface of the upper wall 21a on a rear end side in the X-axis direction. The rear portions 21f each include a curved portion 21h that is continuous with the surface of the upper wall 21a on the rear end side in the X-axis direction and that extends rearward and downward while being curved, and a flat plate portion 21i that is continuous with a lower end of the curved portion 21h and that extends downward. The flat plate portion 21i has a flat surface orthogonal to the X-axis direction.

The guide portions 21g are members that abut on part of the lock engagement portions 32 when an operation for releasing engagement between the connector engagement portions 11g and the lock engagement portions 32 is performed (details will be described later). When the operation for releasing the engagement is performed, the guide portions 21g abut on part of the lock engagement portions 32 to restrict a direction of the operation to a direction of releasing the engagement between the connector engagement portions 11g and the lock engagement portions 32 (details will be described later). As described above, in the present embodiment, the guide portions 21g are formed on the shell 21. The guide portions 21g are provided in such a way as to be continuous with both ends of the upper wall 21a in the Y-axis direction and the rear end portion of the upper wall 21a in the X-axis direction.

The guide portions 21g are provided on side surfaces of the upper wall 21a at ends in the Y-axis direction. The guide portions 21g each include a curved portion 21j, a flat plate portion 21k, and an inclined portion 21l. The curved portion 21j is continuous with the side surface of the upper wall 21 a at one of the ends in the Y-axis direction and extends while being curved outward and downward in the Y-axis direction. The flat plate portion 21k is continuous with a lower end of the curved portion 21j and extends downward. The flat plate portion 21k has a flat surface orthogonal to the Y-axis direction. The inclined portion 21l is continuous with a lower end of the flat plate portion 21k and extends downward while being inclined inward in the Y-axis direction. In other words, the inclined portion 21l extends outward in the Y-axis direction from a lower side to an upper side. When part of the lock engagement portions 32 at a time of disengagement abuts on the inclined portions 21l, the lock engagement portions 32 move outward in the Y-axis direction as being pulled upward (details will be described later).

Note that the side wall 21b and the front portion 21c of the shell 21 may be integrally formed and may be formed separately from the upper wall 21a. The side wall 21b and the front portion 21c are fixed to the housing 22 through insert molding, and a portion including the upper wall 21a is press-fitted and fixed to the housing 22. A method for assembling the shell 21 with respect to the housing 22 is not limited to the above-described method.

The plurality of conductive terminals 23 is formed of, for example, a pressed metal plate-like member, and have conductivity. As illustrated in FIG. 8B, the plurality of conductive terminals 23 is arranged side-by-side along the Y-axis direction. As illustrated in FIG. 6, the conductive terminals 23 extend along the X-axis direction and each include a connecting portion 23a, an intermediate portion 23b, and a contact portion 23c.

The connecting portion 23a extends on an upper end surface of the side wall 22b along the inner conductor 61 at the distal end portion of the electric cable 60, and is connected to the inner conductor 61 in an exposed state via solder or the like. The intermediate portion 23b connects the connecting portion 23a and the contact portion 23c. The intermediate portion 23b is continuous with a front end of the connecting portion 23a in the X-axis direction, extends downward, and then extends rearward (in a direction of the central wall 12c of the receptacle connector 10) along a lower surface of the side wall 22a. The contact portion 23c comes into contact with the corresponding conductive terminal 13 of the receptacle connector 10 in the fitted state of the receptacle connector 10 and the plug connector 20. The contact portion 23c is continuous with a rear end of the intermediate portion 23b in the X-axis direction and extends upward along the side wall 22a.

### Lock Member

The lock member 30 will be described in detail with reference to FIGS. 1 to 6, 8A, 8B, 10A, 10B, 11A, and 11B. The lock member 30 is attached to the plug connector 20 and configured to hold the fitted state where the plug connector 20 and the receptacle connector 10 are fitted to each other. As illustrated in FIGS. 1 to 3, for example, the lock member 30 extends along the Y-axis direction while facing the main surface 50s of the circuit board 50, and is attached to the plug connector 20.

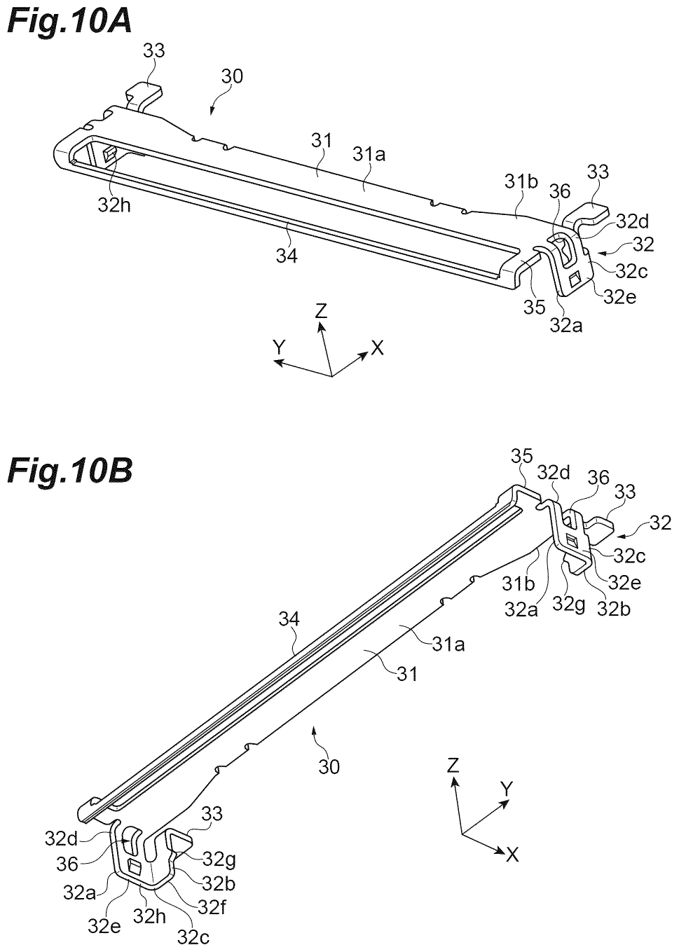

The lock member 30 is formed of, for example, a pressed metal plate-like member, and has elasticity and conductivity. As illustrated in FIGS. 8A, 8B, 10A, and 10B, the lock member 30 includes a main body portion 31, the lock engagement portions 32 and 32, release operation portions 33 and 33, the rotary shaft 34, and connecting portions 35 and 35.

As illustrated in FIGS. 8A and 10A, the main body portion 31 is a plate-like member along the XY plane, and configured to sandwich, between the main body portion 31 and the receptacle connector 10, the plug connector 20 in the fitted state where the plug connector 20 is fitted to the receptacle connector 10. The main body portion 31 includes a central portion 31a has a substantially rectangular plate shape and extending in the Y-axis direction and outer end portions 31b and 31b extending outward in the Y-axis direction from both ends of the central portion 31a in the Y-axis direction. Rear end portions of the outer end portions 31b in the X-axis direction extend in such a way as to expand rearward in the X-axis direction as extending outward in the Y-axis direction. The outer end portions 31b are coupled to the lock engagement portions 32. The direction (Y-axis direction) in which the main body portion 31 extends and the direction (Z-axis direction) in which the lock engagement portions 32 described later extends are orthogonal to each other.

The lock engagement portions 32 and 32 are members configured to be engageable with the connector engagement portions 11g and 11g arranged at the ends 10a and 10b of the receptacle connector 10. When the X-axis direction in which the electric cables 60 extend in such a way as to approach the plug connector 20 is defined as forward and the X-axis direction in which the electric cables 60 extend in such a way as to be away from the plug connector 20 is defined as rearward, the lock engagement portions 32 and 32 are disposed on the plug connector 20 closer to a rear side. Here, the rear side refers to, for example, a part of the plug connector 20 located at a position behind at least the center of an entire region of the plug connector 20 in the X-axis direction. More specifically, the lock engagement portions 32 and 32 are disposed behind the rotary shaft 34 and in front of the release operation portions 33 and 33 (that is, a position sandwiched between the rotary shaft 34 and the release operation portions 33 and 33) in the X-axis direction. As illustrated in FIGS. 8A, 8B, 10A, and 10B, the lock engagement portions 32 each include a first hanging portion 32a, a second hanging portion 32b, and a coupling portion 32c.

The first hanging portion 32a is a portion extending downward (in the Z-axis direction and in a direction approaching the receptacle connector 10 in the fitted state) from an outer end of the main body portion 31 in the Y-axis direction (specifically, the outer end portion 31b). The first hanging portion 32a includes a first portion 32d that is continuous with an outer end of the outer end portion 31b in the Y-axis direction and that extends outward and downward in the Y-axis direction and a second portion 32e that is continuous with a lower end of the first portion 32d and that extends downward. The first portion 32d and the second portion 32e have substantially the same length in the X-axis direction (width). In the first portion 32d and the second portion 32e (specifically, an upper end portion of the second portion 32e continuous with the first portion 32d), a slit 36 (notch) is formed at a central portion in the X-axis direction. As described above, the slit 36 is continuously formed over the first portion 32d and the second portion 32e of the first hanging portion 32a, which is part of the corresponding lock engagement portion 32. The second portion 32e is a plate-like member along the XZ plane, and includes, below the slit 36, a flat surface orthogonal to the Y-axis direction.

An engagement portion 32h is provided on a flat surface below the portion of the second portion 32e where the slit 36 is formed. The engagement portion 32h is provided on an inner surface of the second portion 32e in the Y-axis direction, and is a protruding portion protruding inward in the Y-axis direction. As illustrated in FIG. 5, the engagement portion 32h is engaged with the corresponding connector engagement portion 11g of the receptacle connector 10 in the fitted state.

As illustrated in FIGS. 10A and 10B, the coupling portion 32c is configured to couple the first hanging portion 32a and the second hanging portion 32b. The coupling portion 32c is connected to a rear end portion of the second portion 32e of the first hanging portion 32a in the X-axis direction.

As illustrated in FIGS. 4 and 10B, the second hanging portion 32b is a plate-like member that is coupled to the first hanging portion 32a via the coupling portion 32c and that extends along a YZ plane. The second hanging portion 32b includes a flat portion 32f and a release guide portion 32g. The flat portion 32f is a plate-shaped member that is continuous with the coupling portion 32c and that extends in the Z-axis direction and the Y-axis direction. An upper end of the flat portion 32f is continuous with the corresponding release operation portion 33.

The release guide portion 32g is provided on an inner surface of the flat portion 32f in the Y-axis direction, and is a protruding portion protruding inward in the Y-axis direction. The release guide portion 32g is provided, for example, below a central portion of the flat portion 32f in the Z-axis direction. The release guide portion 32g abuts on the inclined portion 21l of the corresponding guide portion 21g in a state where the lock member 30 is attached to the plug connector 20 and the engagement portion 32h is engaged with the corresponding connector engagement portion 11g. Note that the release guide portion 32g need not necessarily abut on the inclined portion 21l in the engaged state, and may move along the inclined portion 21l when being pulled upward as described later. In this state, when the release operation portion 33 is pulled upward so as to release the engagement between the connector engagement portion 11g and the engagement portion 32h, the release guide portion 32g moves upward along the inclined portion 21l. Here, the inclined portion 21l extends outward in the Y-axis direction from a lower side to an upper side. The release guide portion 32g moving upward along the inclined portion 21l, therefore, moves outward in the Y-axis direction as it goes upward. When the release guide portion 32g moves outward in the Y-axis direction, the second portion 32e of the first hanging portion 32a also moves outward in the Y-axis direction via the flat portion 32f and the coupling portion 32c, so that the engagement portion 32h provided in the second portion 32e also moves outward in the Y-axis direction. As a result, the engaged state between the engagement portion 32h and the connector engagement portion 11g is released. As described above, when an operation for releasing the engagement is performed, the guide portion 21g (specifically, the inclined portion 21l) abuts on part of the lock engagement portion 32 (specifically, the release guide portion 32g), thereby restricting a direction of the operation to a direction of releasing the engagement between the connector engagement portion 11g and the engagement portion 32h (outward in the Y-axis direction).

As illustrated in FIG. 10B, the release operation portions 33 and 33 are portions coupled to the lock engagement portions 32 and 32 (specifically, the flat portions 32f of the second hanging portions 32b) and configured to enable an operation for releasing the engagement (see FIG. 5) between the connector engagement portions 11g of the receptacle connector 10 and the lock engagement portions 32 (specifically, the engagement portions 32h). The release operation portions 33 and 33 are disposed closer to the rear side of the plug connector 20 in the X-axis direction. More specifically, the release operation portions 33 and 33 are disposed behind the lock engagement portions 32 and 32 in the X-axis direction. As illustrated in FIG. 10B, each release operation portion 33 is a plate-like member continuous with the upper end of the corresponding flat portion 32f and extending along the XY plane. The upper surface (main surface) of the release operation portion 33 is disposed substantially flush with the upper surface (main surface) of the main body portion 31.

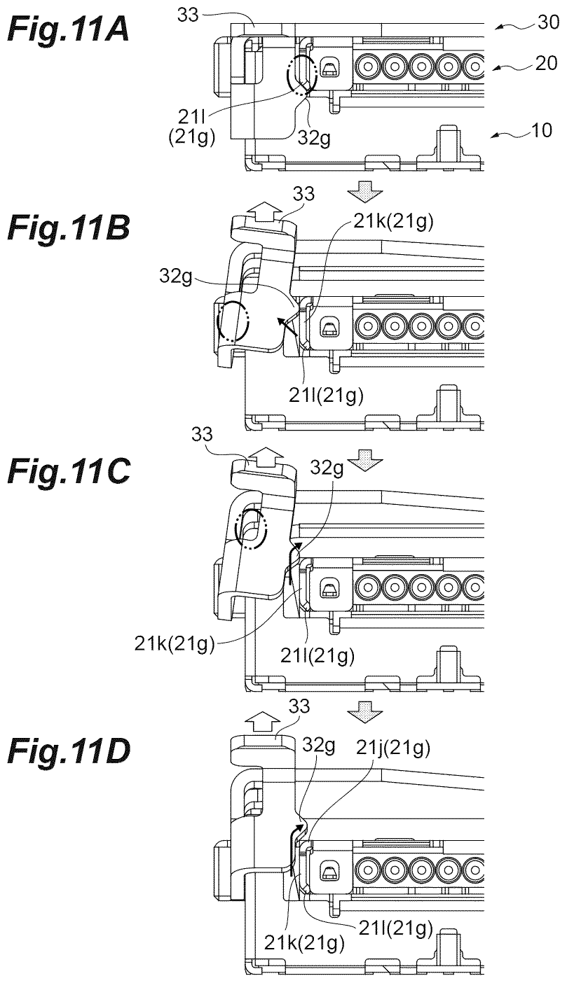

FIGS. 11A to 11D are diagrams schematically illustrating a procedure for unlocking the connector device 1. As illustrated in FIGS. 4 and 11A, in the fitted state of the receptacle connector 10 and the plug connector 20 and the state where the lock member 30 is attached to the plug connector 20 and the engagement portion 32h is engaged with the connector engagement portion 11g (see FIG. 5), the release guide portion 32g of the lock engagement portion 32 abuts on the lower end portion of the inclined portion 21l of the guide portion 21g. When the release operation portion 33 is moved upward from this state as illustrated in FIG. 11B, the release guide portion 32g moves upward and outward in the Y-axis direction along the inclined portion 21l. Accordingly, the engagement portion 32h provided in the second portion 32e of the first hanging portion 32a also moves outward in the Y-axis direction. When the release guide portion 32g climbs over the inclined portion 21l and reaches the flat plate portion 21k of the guide portion 21g, the engagement between the engagement portion 32h moved outward in the Y-axis direction and the connector engagement portion 11g is released, and a lock is released.

When the release operation portion 33 is further moved upward as illustrated in FIG. 11C and the release guide portion 32g reaches above the curved portion 21j of the guide portion 21g as illustrated in FIG. 11D, the release guide portion 32g no longer returns downward (that is, the engagement portion 32h no longer returns to a position of engagement with the connector engagement portion 11g). In this state, the lock member 30 is removed.

As illustrated in FIGS. 10A and 10B, the rotary shaft 34 extends along the Y-axis direction. As illustrated in FIG. 6, the rotary shaft 34 is disposed closer to a front side of the plug connector 20. Here, the front side refers to, for example, a part of the plug connector 20 located at a position in front of at least the center of the entire region of the plug connector 20 in the X-axis direction. The rotary shaft 34 is coupled to the main body portion 31 via connecting portions 35 and 35 provided at a front end of the main body portion 31 in the X-axis direction and at both ends of the main body portion 31 in the Y-axis direction. Each connecting portion 35 is provided in such a way as to curve downward from the main body portion 31 toward the rotary shaft 34. As illustrated in FIG. 6, the rotary shaft 34 is held by being placed on the bearing 21e and sandwiched between the bearing 21e and the upper wall 21a. As a result, the lock member 30 is attached to the plug connector 20 in such a way as to be rotatable about the rotary shaft 34. When the engagement between the engagement portion 32h and the connector engagement portion 11g described above is released, the engagement is released through an operation of lifting the release operation portion 33, and the lock member 30 rotates about the rotary shaft 34.

### Effects

As described above, the connector device 1 includes the plug connector 20 and the lock member 30 attached to the plug connector 20 and configured to hold the fitted state where the plug connector 20 and the receptacle connector 10 are fitted to each other. The lock member 30 includes the lock engagement portions 32 configured to be engageable with the connector engagement portions 11g provided in the receptacle connector 10 and the release operation portions 33 coupled to the lock engagement portions 32 and configured to enable an operation for releasing the engagement between the connector engagement portions 11g and the lock engagement portions 32. The plug connector 20 includes the guide portions 21g that abut on part of the lock engagement portions 32 when the above-described operation for releasing the engagement is performed. When the operation for releasing the engagement is performed, the guide portions 21g (specifically, the inclined portions 21l) abut on the release guide portions 32g of the lock engagement portions 32, thereby restricting a direction of the operation to a direction of releasing the engagement between the connector engagement portions 11g and the lock engagement portions 32.

In the connector device 1 according to the present embodiment, when the operation for releasing the engagement is performed using the release operation portions 33 in a situation where the lock engagement portions 32 of the lock member 30 and the connector engagement portions 11g of the receptacle connector 10 are engaged with each other, the inclined portions 21l of the guide portions 21g abut on the release guide portions 32g of the lock engagement portions 32, and a direction of the operation is restricted to a direction of releasing the engagement. With this configuration, it may be possible to prevent a situation where the engagement is not released due to the direction of the operation, and it may be possible to smoothly release the lock.

The plug connector 20 includes the plurality of conductive terminals 23, the housing 22 that holds the plurality of conductive terminals 23, and the shell 21 that covers the housing 22, and the guide portions 21g are formed on the shell 21. Since the guide portions 21g are formed on the shell 21, it may be possible to appropriately guide the release guide portions 32g using the guide portions 21g at portions at which the lock member 30 may be readily contacted.

The lock member 30 further includes the main body portion 31 configured to sandwich the plug connector 20 in the fitted state between the lock member 30 and the receptacle connector 10 and coupled to the lock engagement portions 32, and the direction in which the lock engagement portions 32 extend and the direction in which the main body portion 31 extends may be orthogonal to each other. Since the main body portion 31 and the lock engagement portions 32 are included, it may be possible to hold the fitted state using the lock member 30.

The slits 36 may be formed in part of the lock engagement portions 32. With this configuration, for example, it becomes easier to swing when releasing the engagement, and the lock may be released more smoothly.

### Second Embodiment

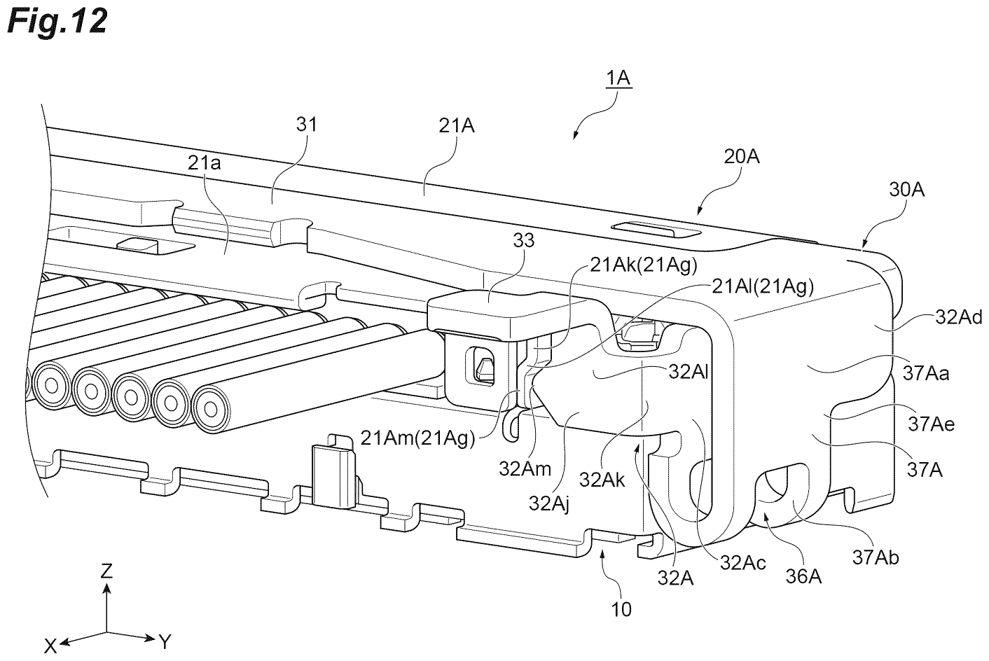

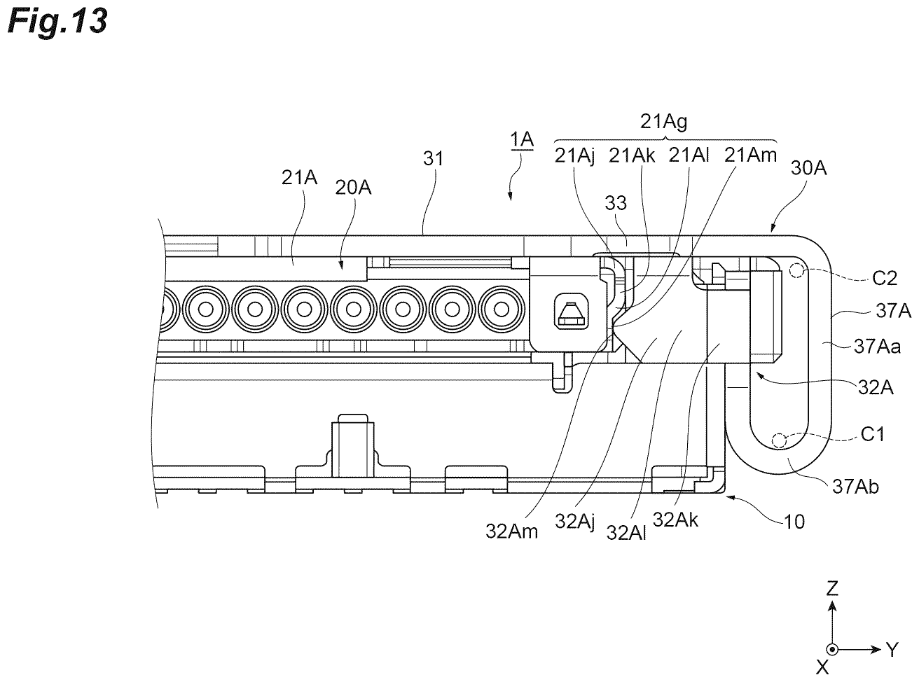

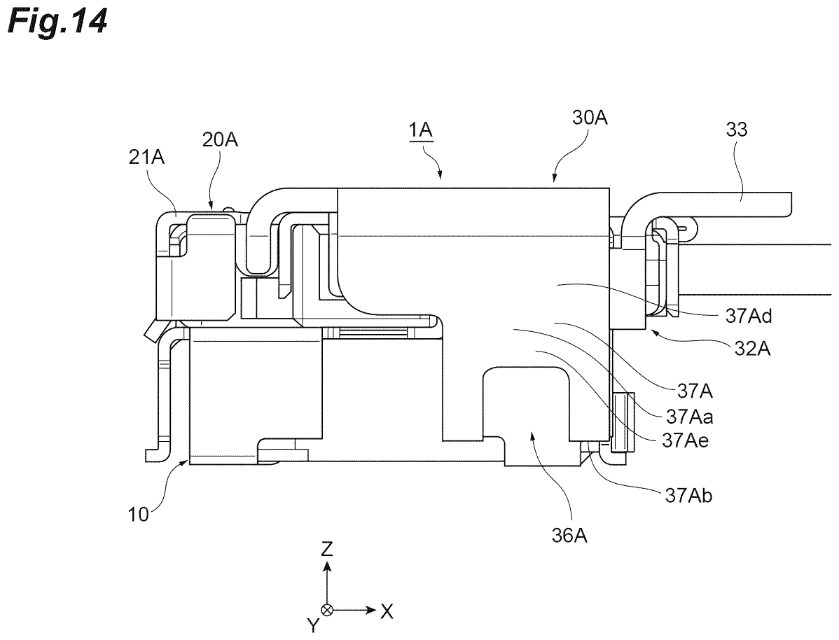

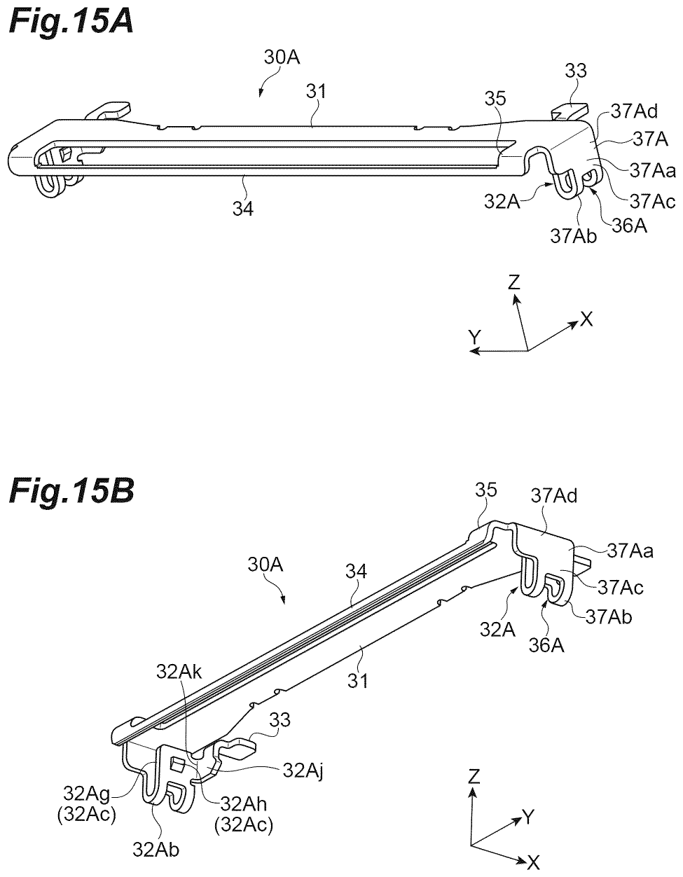

A second embodiment of the present disclosure will be described hereinafter with reference to FIGS. 12 to 14,15A, and 15B. Note that in the second embodiment, differences from the first embodiment will be mainly described. FIG. 12 is a perspective view illustrating a connector device 1A according to the second embodiment. FIG. 13 is a rear view illustrating the connector device 1A of FIG. 12. FIG. 14 is a side view illustrating the connector device 1A of FIG. 12. FIGS. 15A and 15B are perspective views illustrating a lock member 30A included in the connector device 1A of FIG. 12.

As illustrated in FIGS. 12 to 14, the connector device 1A includes a receptacle connector 10 (a mating connector or a second connector) and an electrical connector including a plug connector 20A (a connector portion or a first connector) and a lock member 30A. In the connector device 1A according to the second embodiment, the receptacle connector 10 is similar to the connector device 1 according to the first embodiment. Here, the plug connector 20A and the lock member 30A, which are different from the equivalents in the first embodiment, will be mainly described.

The plug connector 20A is substantially similar to the plug connector 20 of the connector device 1 according to the first embodiment, but configuration of a shell 21A, or more specifically, configuration of guide portions 21Ag of the shell 21A, is different from the configuration of the plug connector 20. As illustrated in FIGS. 12 and 13, the guide portions 21Ag are provided on side surfaces of the upper wall 21a at ends in the Y-axis direction. The guide portions 21Ag each include a curved portion 21Aj, a first flat plate portion 21Ak, an inclined portion 21Al, and a second flat plate portion 21Am. The curved portion 21Aj is continuous with the side surface of the upper wall 21a at one of the ends in the Y-axis direction and extends while being curved outward and downward in the Y-axis direction. The first flat plate portion 21Ak is continuous with a lower end of the curved portion 21Aj and extends downward. The first flat plate portion 21Ak has a flat surface orthogonal to the Y-axis direction. The inclined portion 21Al is continuous with a lower end of the first flat plate portion 21Ak and extends downward while being inclined inward in the Y-axis direction. In other words, the inclined portion 21Al extends outward in the Y-axis direction from a lower side to an upper side. When part of the corresponding lock engagement portion 32A at a time of disengagement abuts on the inclined portion 21Al, the lock engagement portion 32A moves outward in the Y-axis direction as being pulled upward. The second flat plate portion 21Am is continuous with a lower end of the inclined portion 21Al and extends downward. The second flat plate portion 21Am has a flat surface orthogonal to the Y-axis direction.

As illustrated in FIGS. 12 to 14, 15A and 15B, the lock member 30A includes a main body portion 31, lock engagement portions 32A, release operation portions 33 and 33, a rotary shaft 34, connecting portions 35 and 35, and coupling portions 37A. The lock member 30A has the same configuration as the lock member 30 except for the lock engagement portions 32A and 32A and the coupling portions 37A, but configuration of the lock engagement portions 32A is different from that in the lock member 30 and the coupling portions 37A are included.

The coupling portions 37A are members that couple the lock engagement portions 32A and the main body portion 31 to each other. The coupling portions 37A extend in a U-shape and are coupled to the lock engagement portions 32A and the main body portion 31. The coupling portions 37A each include a hanging portion 37Aa and a folded portion 37Ab.

The hanging portion 37Aa is a portion extending downward (in the Z-axis direction and in a direction approaching the receptacle connector 10 in the fitted state) from an outer end of the main body portion 31 in the Y-axis direction (specifically, the outer end portion 31b). The hanging portion 37Aa includes a first portion 37Ad that is continuous with an outer end (an end closer to the outside) of the outer end portion 31b and that extends downward, and a second portion 37Ae that is continuous with a lower end of the first portion 37Ad and that extends downward. The second portion 37Ae has a length in the X-axis direction (width) of about half that of the first portion 37Ad, and is continuous with only a rear portion of the first portion 37Ad at the lower end in the X-axis direction. The second portion 37Ae has a slit 36A formed at a central portion thereof in the X-axis direction and is bifurcated in the X-axis direction. The slit 36A is continuously formed up to the folded portion 37Ab described hereinafter.

The folded portion 37Ab is a portion that extends in a curved manner in such a way as to fold back inward in the Y-axis direction from a lower end of the hanging portion 37Aa (specifically, a lower end of the second portion 37Ae of the hanging portion 37Aa) and further extending in a curved manner in such a way as to fold back upward from an inner end in the Y-axis direction. As described above, in the folded portion 37Ab, too, the slit 36A is formed at a central portion in the X-axis direction. As described above, the slit 36A is formed in part (the second portion 37Ae and the folded portion 37Ab) of the coupling portion 37A.

As illustrated in FIG. 15B, the lock engagement portions 32A each include a first extending portion 32Ac, a second extending portion 32Aj, and a coupling portion 32Ak.

The first extending portion 32Ac includes a flat plate portion 32Ag that is continuous with an upper end of the folded portion 37Ab and that extends upward and an engagement portion 32Ah. The engagement portion 32Ah is provided on an inner surface of the flat plate portion 32Ag in the Y-axis direction, and is a protruding portion protruding inward in the Y-axis direction. The engagement portion 32Ah is engaged with the corresponding connector engagement portion 11g of the receptacle connector 10 in the fitted state.

As illustrated in FIGS. 12 and 13, the coupling portion 32Ak is configured to couple the first extending portion 32Ac and the second extending portion 32Aj. The coupling portion 32Ak is connected to a rear end portion of the first extending portion 32Ac in the X-axis direction.

As illustrated in FIGS. 12 and 13, the second extending portion 32Aj is a plate-like member that is coupled to the first extending portion 32Ac via the coupling portion 32Ak and that extends along the YZ plane. The second extending portion 32Aj includes a flat portion 32Al and a release guide portion 32Am. The flat portion 32Al is a plate-like member that is continuous with the coupling portion 32Ak and extends in the Z-axis direction and the Y-axis direction. An upper end of the flat portion 32Al is continuous with the corresponding release operation portion 33.

The release guide portion 32Am is provided on an inner surface of the flat portion 32Al in the Y-axis direction, and is a protruding portion protruding inward in the Y-axis direction. The release guide portion 32Am is provided, for example, in the vicinity of a central portion of the flat portion 32Al in the Z-axis direction. The release guide portion 32Am abuts on the second flat plate portion 21Am of the guide portion 21Ag in a state where the lock member 30A is attached to the plug connector 20A and the engagement portion 32Ah is engaged with the connector engagement portion 11g. Note that the release guide portion 32Am need not necessarily abut on the second flat plate portion 21Am in the engaged state, and may move along the inclined portion 21Al when being pulled upward as described later. In this state, when the release operation portion 33 is pulled upward so as to release the engagement between the connector engagement portion 11g and the engagement portion 32Ah, the release guide portion 32Am moves upward along the inclined portion 21Al. Here, the inclined portion 21Al extends outward in the Y-axis direction from a lower side to an upper side. The release guide portion 32Am moving upward along the inclined portion 21Al, therefore, moves outward in the Y-axis direction as it goes upward. When the release guide portion 32Am moves outward in the Y-axis direction, the flat plate portion 32Ag of the first extending portion 32Ac also moves outward in the Y-axis direction via the flat portion 32Al and the coupling portion 32Ak, so that the engagement portion 32Ah provided on the flat plate portion 32Ag also moves outward in the Y-axis direction. As a result, the engaged state between the engagement portion 32Ah and the connector engagement portion 11g is released. As described above, when an operation for releasing the engagement is performed, the guide portion 21Ag (specifically, the inclined portion 21Al) abuts on part of the lock engagement portion 32A (specifically, the release guide portion 32Am), thereby restricting a direction of the operation to a direction of releasing the engagement between the connector engagement portion 11g and the engagement portion 32Ah (outward in the Y-axis direction).

In the operation of releasing the engagement, as illustrated in FIG. 13, the coupling portion 37A may swing with a center C1 (that is, a lower end portion of the folded portion 37Ab) of the U-shaped shaft as an axis of rotation, or may swing with a center C2 (that is, an upper end portion of the hanging portion 37Aa) of an upper shaft as an axis of rotation with the help of rigidity of the entire lock engagement portion 32A.

### Effects

As described above, in the connector device 1A according to the second embodiment, the coupling portions 37A extend in a U-shape and are coupled to the lock engagement portions 32A and the main body portion 31. With this configuration, the fitted state achieved by the lock member 30A may be maintained and the lock member 30A may be smoothly attached and removed thanks to a U-shaped structure that may be readily swung.

In addition, the slits 36A may be formed in at least part of the lock engagement portions 32A and the coupling portions 37A (in the present embodiment, the second portions 37Ae and the folded portions 37Ab of the coupling portions 37A). With this configuration, for example, it becomes easier to swing when releasing the engagement, and the lock may be released more smoothly.

In addition, each lock engagement portion 32A may swing with the center C1 (that is, the lower end portion of the folded portion 37Ab) of the U-shaped shaft of the coupling portion 37A as an axis of rotation when an operation for releasing the engagement is performed. With this configuration, for example, it becomes easier to swing when releasing the engagement, and the lock may be released more smoothly.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. An electrical connector comprising:
a connector configured to be fitted to a mating connector in a first direction, wherein a connection member extending in a second direction intersecting the first direction is configured to be connected to the connector; and
a lock member attached to the connector and configured to maintain a fitted state where the connector and the mating connector are fitted to each other,
wherein the lock member comprises:
at least one lock engagement portion configured to be engaged with at least one mating connector engagement portion of the mating connector; and
at least one release operation portion coupled to the lock engagement portion and configured to enable an operation for releasing an engagement between the mating connector engagement portion and the lock engagement portion, and
wherein the connector comprises a guide portion and, when the operation for releasing is performed, the guide portion abuts a part of the lock engagement portion to realize the operation for releasing.

2. The electrical connector according to claim 1,
wherein the guide portion comprises an inclined portion that extends outward in a third direction intersecting the first direction and the second direction, when the inclined portion extends in a direction toward the connector from the mating connector.

3. The electrical connector according to claim 2,
wherein, when the operation for releasing is performed, the release operation portion is pulled in a direction toward the connector from the mating connector, and the lock engagement portion abuts the inclined portion and moves outward in the third direction.

4. The electrical connector according to claim 2,
wherein the lock engagement portion abuts the inclined portion in the fitted state, and
wherein, when the operation for releasing is performed, the release operation portion is pulled in a direction toward the connector from the mating connector, and the lock engagement portion moves outward in the third direction.

5. The electrical connector according to claim 2,
wherein the guide portion further comprises:
a curved portion that extends outward in the third direction, when the curved portion extends in a direction toward the mating connector from the connector; and
a flat plate portion that is continuous with one end of the curved portion, extends in a direction toward the mating connector from the connector, and is continuous with one end of the inclined portion.

6. The electrical connector according to claim 1,
wherein, when a direction in which the connection member extends toward the connector is defined as forward in the second direction and a direction in which the connection member extends away from the connector is defined as rearward in the second direction, the lock engagement portion is disposed closer to a rear side of the lock member in the second direction than a front side of the lock member in the second direction.

7. The electrical connector according to claim 6,
wherein, when a direction in which the connection member extends toward the connector is defined as forward in the second direction and a direction in which the connection member extends away from the connector is defined as rearward in the second direction, the lock engagement portion is disposed in front of the release operation portion in the second direction.

8. The electrical connector according to claim 2,
wherein the lock engagement portion comprises a protruding engagement portion that protrudes inward in the third direction and is engaged with the mating connector engagement portion in the fitted state.

9. The electrical connector according to claim 8,
wherein the lock engagement portion comprises a release guide portion that protrudes inward in the third direction and abuts the inclined portion of the guide portion in the fitted state.

10. The electrical connector according to claim 9,
wherein, when the operation for releasing is performed, the release guide portion moves outward in the third direction along the inclined portion, and
wherein, while the release guide portion moves outward in the third direction, the protruding engagement portion moves outward in the third direction and an engaged state between the protruding engagement portion and the mating connector engagement portion is released.

11. The electrical connector according to claim 9,
wherein the guide portion further comprises:
a curved portion that extends outward in the third direction, when the curved portion extends in a direction toward the mating connector from the connector; and
a flat plate portion that is continuous with one end of the curved portion, extends in a direction toward the mating connector from the connector, and is continuous with one end of the inclined portion, and
wherein, when the operation for releasing has been performed, the release operation portion is further pulled in a direction toward the connector from the mating connector, and the release guide portion reaches one end of the curved portion, the release guide portion no longer returns in a direction toward the mating connector from the connector.

12. The electrical connector according to claim 1,
wherein the connector comprises a plurality of conductive terminals, a housing that holds the plurality of conductive terminals, and a shell that covers the housing, and
wherein the guide portion is formed on the shell.

13. The electrical connector according to claim 1,
wherein the lock member further comprises a main body portion that sandwiches the connector between the mating connector in the fitted state and is coupled to the lock engagement portion, and
wherein a direction in which the lock engagement portion extends and a direction in which the main body portion extends are orthogonal to each other.

14. The electrical connector according to claim 13,
wherein an upper surface of the release operation portion is disposed substantially flush with an upper surface of the main body portion.

15. The electrical connector according to claim 13,
wherein the lock engagement portion comprises a notch.

16. The electrical connector according to claim 1,
wherein the lock member further comprises:
a main body portion that sandwiches the connector between the mating connector in the fitted state; and
a coupling portion that couples the lock engagement portion and the main body portion to each other,
wherein a direction in which the lock engagement portion extends and a direction in which the main body portion extends are orthogonal to each other, and
wherein the coupling portion extends in a U-shape and is coupled to the lock engagement portion and the main body portion.

17. The electrical connector according to claim 16,
wherein at least one of the lock engagement portion and the coupling portion comprises a notch.

18. The electrical connector according to claim 17,
wherein the lock engagement portion swings about a center of a U-shaped shaft of the coupling portion as an axis of rotation when the operation for releasing the engagement is performed.

19. A connector device comprising:
a first connector to which a connection member extending in a second direction intersecting a first direction is configured to be connected;
a second connector connected to a board and configured to be fitted to the first connector in the first direction; and
a lock member attached to the first connector and configured to maintain a fitted state where the first connector and the second connector are fitted to each other,
wherein the lock member comprises:
at least one lock engagement portion configured to be engaged with at least one connector engagement portion of the second connector; and
at least one release operation portion coupled to the lock engagement portion and configured to enable an operation for releasing an engagement between the connector engagement portion of the second connector and the lock engagement portion, and
wherein the first connector comprises a guide portion and, when the operation for releasing is performed, the guide portion abuts a part of the lock engagement portion to realize the operation for releasing.

20. The electrical connector according to claim 19,
wherein the guide portion comprises an inclined portion that extends outward in a third direction intersecting the first direction and the second direction, when the guide portion extends in a direction toward the first connector from the second connector.
